(19) United States
(12) Patent Application Publication
(10) Pub. No.: US 2005/0175744 A1
(43) Pub. Date: Aug. 11, 2005

(54) Dry ice pouch

(76) Inventor: Eric Taneda, Bellevue, WA (US)

Correspondence Address: Eric Taneda, 1800 136th PI NE #102, Bellevue, WA, 98005, US

(21) Appl. No.: 10/776,985

(22) Filed: Feb. 10, 2004

(51) Int. Cl. A23B 4/00

(52) U.S. Cl. 426/109

(57) ABSTRACT

A porous pouch completely encasing dry ice, in disposable or reusable form, can be handled with bare hands safely and used to keep frozen foodstuffs frozen, and also to enable serving of a frozen dessert such as Dippin' Dots ice cream, while minimizing the problem of said frozen dessert starting to melt immediately after being served, prior to consumption, without dangers of bare pieces of dry ice going into the mouth.

### BACKGROUND OF FIELD OF INVENTION

This invention is in the field of preserving frozen foodstuffs. More specifically, it is a) keeping frozen foodstuffs intended for more or less immediate consumption in frozen state, in optimal frozen state from the time it is sold until the time it is actually consumed; and b) transporting or storing frozen foodstuffs wherein dry ice in some form is typically used for said transport activity.

### BACKGROUND OF PRIOR ART

Typically, when someone wants to preserve some frozen foodstuff during transport, he will use a freezer, an ice box, or dry ice.

A freezer works well for carrying a large quantity of frozen foodstuff, such as when delivery trucks deliver frozen foods to grocery stores, but does not work very well on a smaller scale, such as when someone is transporting purchased frozen foodstuffs from a grocery store to his home, or when someone orders frozen dessert such as Dippin' Dots ice cream to go. It is also very costly and difficult to maintain very low temperatures, such as can be achieved by using dry ice.

An ice box is more often used as a substitute for a refrigerator, to keep beverages cold, than to keep frozen foodstuff frozen, because said ice box contains melting ice which not cold enough to maintain sufficiently low temperature to preserve frozen foodstuffs. But said ice box has the advantage over freezers, in that it is small and does not require a power source.

Dry ice is often used to transport ice cream cakes, packages of frozen foods, and similar frozen foodstuffs, but carries with it the inherent dangers of accidentally causing frost bite on skin that may come in contact with said dry ice, and if the frozen foodstuff is intended to be consumed, and if loose pieces of dry ice get mixed into the foodstuff, it can become hazardous to eat said foodstuff with dry ice particles. For example, Dippin' Dots ice cream requires very cold temperature, and is transported in blocks of dry ice, but when you order it at a stand or at a McDonald's, they do not provide any dry ice presumably because of this hazard.

### SUMMARY

This invention comprises dry ice completely enrobed in paper or other porous outer covering as a means to prevent frost bite and other hazards of handling dry ice during routine handling of said dry ice near frozen foodstuff during transport and general handling and also as a means to prevent dangerous and accidental oral consumption of loose pieces of dry ice in the course of consuming said frozen foodstuff or foodstuff that has been in contact with said frozen foodstuff.

### DRAWING FIGURES

FIG. 1 drawing shows a dry ice pouch, comprising porous paper pouch completely enrobing dry ice.

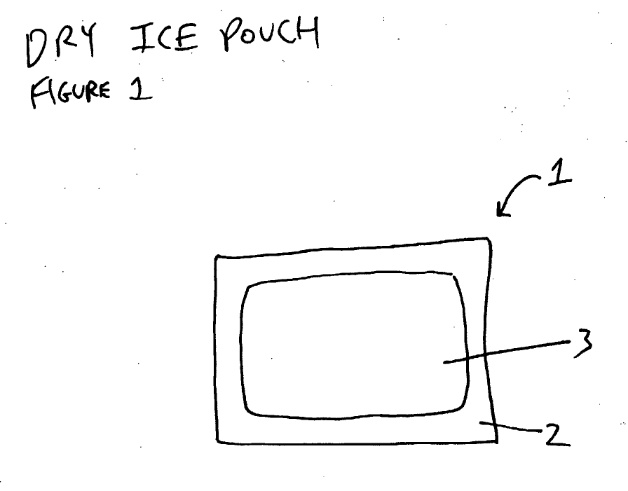

FIG. 2 drawing shows said assembly embedded in a serving of Dippin' Dots ice cream, enabling said serving to remain in optimal serving condition for a period of time greater than if said serving was served without said assembly.

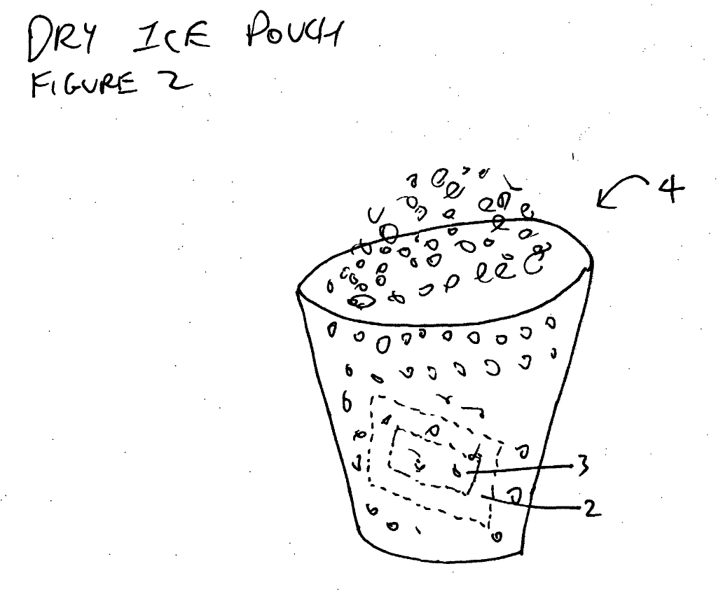

### PART NUMBERS

1. An assembly referred to as a dry ice pouch.

2. Paper or other pourous material.

3. Dry ice fully enrobed in said paper or pourous material.

4. The assembly referred to as a serving of Dippin' Dots ice cream with dry ice pouch contained therein to preserve frozen state of said Dippin Dots ice cream after being served to a customer.

### Description of Preferred Embodiment

The preferred embodiment comprises the type of paper-like material used to encase silica gel as a desiccant, wherein dry ice is contained by said paper-like material in the place of silica gel, and referred to as a dry ice pouch.

The dry ice pouch once deployed is suitable inclusion within frozen foodstuff, to keep said foodstuff suitably frozen, especially when said foodstuff comprises loose elements and is required to be maintained at a substantially below freezing temperature, for example Dippin' Dots ice cream.

The dry ice pouch is also suitable for use by a grocery store and similar retailers and wholesalers of frozen foodstuff, to provide to customers who wish to keep their frozen foods frozen while said foodstuff they purchased or ordered is in transit.

The dry ice pouch should be manufactured and sent to their users in a form that prevents the dry ice from completely sublimating before they can be deployed, since dry ice is sealed in, such sublimation would render the dry ice pouch useless. For example, dry ice pouches can be shipped in bundles in a container that is typically used to ship regular dry ice or assembled on-site where said dry ice pouch is needed.

### Operation of Preferred Embodiment

Dry ice pouches can be stored in a dry ice pouch container that minimizes sublimation of the dry ice, and a person who is putting frozen foodstuff in a foodstuffs container for a customer can reach into said dry ice pouch container to grab some dry ice pouches, and throw them in the said foodstuffs container along with said frozen foodstuffs. Since there is no direct contact between skin and dry ice, the dry ice pouches are safe to handle directly with the hands.

A stand selling a frozen dessert such as Dippin' Dots ice cream, may have along side said frozen dessert, some dry ice pouches, and upon a customer ordering said frozen dessert, said dry ice pouches may be inserted singularly or in multiples at the bottom of a clear plastic container used to serve said frozen dessert, whereupon the said frozen dessert served will not melt as quickly as it would have otherwise melted without said dry ice pouches being placed in amidst particles of said frozen dessert within said clear plastic container.

### Alternate Embodiments and Operations

While a relatively small pouch similar to that used for desiccants is contemplated, with the difference that it is dry ice which is placed in a pouch rather than silica gel, it is also possible to make said pouch larger for cases when the frozen foodstuff to be protected from melting is larger. For example, it is possible to encase one pound of dry ice in pebble form, and fully encase it in reusable heavy canvass cloth pouch, and utilize this form of dry ice pouch to keep a large frozen fish from melting, without the risks and inconveniences inherent in handling dry ice directly.

1) An assembly comprising:
a. Dry ice;
b. Paper or other material completely enrobing and encasing and preventing escape of said solid dry ice matter with a means for carbon dioxide to escape said pouch or bag, such as by said paper or other material being of a porous nature.

2) An assembly as in #1 comprising dry ice encased in the paper-like material as used to encase silica gel as desiccant, intended for disposable use.

3) An assembly as in #2 placed specifically inside a frozen dessert such as Dippin' Dots ice cream cup to keep said frozen dessert from melting for an extended period of time after being served.

4) An assembly as in #1 comprising dry ice encased in material such as canvass or cloth, of sufficiently heavy weight to protect someone handling said assembly from easily receiving frost bite injury.

5) An assembly as in #4 utilized specifically to transport frozen foodstuffs that would normally use dry ice in raw form, for the benefit of reducing inherent risks of frost bite injury in handling dry ice directly.

6) An assembly as in #5 wherein said heavy canvass or cloth is in reusable form with zipper or other method of enabling the user to open said pouch and insert more dry ice.

7) An assembly as in #1 comprising dry ice encased in porous plastic or other man-made material specifically engineered to withstand cold temperature but with sufficiently low heat conductivity such that handling of said assembly is substantially safer with respect to the danger of frost bite injury than handling dry ice directly.
